(19) United States
(12) Patent Application Publication
(10) Pub. No.: US 2025/0254757 A1
(43) Pub. Date: Aug. 7, 2025

(54) METHOD FOR DIRECTLY HEATING AT LEAST ONE ENERGY STORAGE MODULE

(71) Applicant: PULSETRAIN GMBH, Karlshuld (DE)

(72) Inventors: Manuel Kuder, München (DE); Florian Schwitzgebel, Neubiberg (DE)

(21) Appl. No.: 18/854,406

(22) PCT Filed: Apr. 17, 2023
(86) PCT No.: PCT/EP2023/059927

§ 371 Date: Oct. 4, 2024

(30) Foreign Application Priority Data
Apr. 28, 2022 (DE) 10 2022 110 424.9

(51) Int. Cl. H05B 1/02; H01M 10/615; H01M 10/63

(52) U.S. Cl. CPC H05B 1/0202; H01M 10/615; H01M 10/63

(57) ABSTRACT

The invention relates to a method for directly heating at least one energy storage module with a multilevel converter system, in which a multiplicity of energy storage modules and transistors are provided, wherein each energy storage module can be connected in parallel or in series with the respective adjacent energy storage module, and the energy storage modules, preferably the transistors, are switched in such a manner that at least 10 one energy storage module is heated, wherein at least one transistor has a switching frequency of at least 1 Hz.

The invention relates to a method for directly heating at least one energy storage module, in which a multiplicity of energy storage modules and transistors are provided.

Previous energy stores were usually loaded with DC voltage (DC). This is due to the structure of conventional converter systems. In this case, an attempt is made to keep the AC voltage components, that is to say harmonic oscillations, away from the energy stores.

Since many energy stores have to be connected in series or in parallel in this case, a battery management system (BMS) is required. A DC link capacitor, for example, may be connected downstream of the energy stores. Said capacitor is used to further smooth the three-phase currents of the converter and to keep high-frequency oscillations away from the energy stores and to intercept switching overshoots since the inductance of the energy stores would continue to drive the current. The aim of this procedure is to load the energy stores with DC since it is assumed in this case that this contributes to the resistance of the battery cell and reduces the losses.

In a conventional electric vehicle for example, the converters which pass on the energy to the electric motor and deliver it to the battery again during braking energy recovery (recuperation) may be provided on the DC bus. Charging devices which can operate with AC voltage (AC) or DC voltage (DC) can also be connected to this bus, for example.

These converters are usually in the form of two-point converters, for example in the form of a B6 bridge in the case of a three-phase design, or—in particular in the field of solar installations—in the form of a three-point converter.

As an alternative to bridge circuits as converters, so-called multilevel converter systems (MMC systems) are known.

Batteries, for example rechargeable batteries, capacitors, fuel cells and/or solar installations, can be used, for example, as energy stores or energy sources. In this case, the energy stores are not hard-wired to one another, but are rather combined as individual submodules. This structure is required for each phase. Therefore, the energy stores are divided among these phases and can be permanently connected in series or in parallel, for example.

Batteries are chemical energy stores which behave according to the so-called Arrhenius equation. The reaction rate increases with each 10° C. temperature difference. Therefore, it is advantageous in terms of fast charging that the temperature of the batteries is increased. It is likewise advantageous to increase the temperature of the energy storage modules, for example in winter, in order to avoid damaging the batteries unnecessarily.

This has hitherto been resolved by installing external, for example electrical, heating elements in the region of the energy stores or producing additional losses in the motor or a central converter.

However, this is associated with additional costs. The energy storage modules are also heated only indirectly, which results in heat losses as a result of transport and/or emission.

It is therefore an object of the invention to provide a method for directly heating at least one energy storage module, which has a high degree of efficiency.

This object is achieved by means of the method having the features of claim 1.

According to the invention, the method is designed to directly heat at least one energy storage module with a multilevel converter system or can be used for this purpose.

At least one energy storage module is heated directly, that is to say virtually internally, immediately or in an integrated manner. Therefore, there is no need for any external, for example electrical, heating elements.

The energy storage module may be a store of an electrical source, preferably a frequency-dependent electrical source, for example a battery, for example a rechargeable battery, a fuel cell, a solar cell and/or a (super) capacitor.

The method can be used, for example, in electric vehicles, for example electric automobiles, electric trucks and/or electric buses. Use in hydrogen vehicles is also likewise conceivable. This method can also be applied to stationary energy stores and/or other converter systems which are used on the power grid and/or are operated by an AC voltage motor.

A multiplicity of energy storage modules and transistors are provided.

A multilevel converter system, preferably a modular multilevel converter system, describes a type of arrangement or wiring of a plurality of energy storage modules and/or transistors.

Each energy storage module may have at least one or precisely one battery, for example a rechargeable battery, and/or at least one or precisely one capacitor.

The transistors are used, for example, as switches which can be used to select current and/or voltage paths, for example. As a result, the energy storage modules can be incorporated into or excluded from a desired configuration, for example.

At least or precisely two, three, four, five, six, seven, eight, nine, ten or more transistors are preferably assigned to each energy storage module.

The transistor may be designed, for example, for a voltage of less than 500 V, 400 V, 300 V, 200 V, 100 V, 50 V, 40 V, 30 V, 20 V or 10 V. The transistor can preferably be designed for a voltage of between 2 V and 8 V, for example 3 V, 4 V, 5 V, 6 V or 7 V.

Each energy storage module may be connected in parallel and/or in series with the respective adjacent energy storage module. Each energy storage module can preferably be connected in series with the respective adjacent energy storage module. The possibility of connection in parallel is advantageous, but not necessary.

The adjacent energy storage modules are preferably connected to one another via two current and/or voltage paths in each case. A transistor may be assigned to each path.

For example, three transistors are provided between two adjacent energy storage modules. As a result, the energy storage modules may be connected in parallel or in series, for example.

Multilevel converter systems are considerably more versatile than bridge circuits. Virtually any desired configurations can thus be produced. For example, the energy storage modules can be connected in any desired manner, for example in parallel or in series, with one another. Individual energy storage modules can also be incorporated into or excluded from a desired configuration.

The energy storage modules, preferably the transistors, are switched in such a manner that at least one energy storage module is heated.

Losses are preferably artificially increased in the process. These losses produce heat which is directly output in the region of the energy stores.

Switching can preferably be carried out in a pulse-width-modulated (PWM) manner.

At least one transistor, preferably all transistors, has/have a switching frequency of at least 1 Hz, 2 Hz, 3 Hz, 4 Hz, 5 Hz, 6 Hz, 7 Hz, 8 Hz, 9 Hz, 10 Hz, 15 Hz, 20 Hz, 30 Hz, 40 Hz, 50 Hz or 100 Hz.

Multilevel converter systems, which are mainly used as a variable DC voltage or battery management systems, are conventionally switched comparatively slowly or rarely, for example less than once per second. This is due to the fact that such systems are power-optimized and losses, for example switching losses, are intended to be minimized. The DC link voltage must also be changed only slowly in this case since the requirements for the DC link voltage change only slowly.

Contrary to the normal procedure of keeping losses as low as possible, losses are intended to be artificially increased according to the invention in order to produce heat.

A converter section may have 100 stages, for example. The entire converter section may therefore have 100 times the frequency.

For example, the maximum switching frequency of a transistor and/or of the entire converter section may be at least 50 kHz, 60 kHz, 70 GHz, 80 kHz, 90 kHz, 100 kHz, 150 kHz, 200 kHz, 250 kHz, 300 kHz, 400 kHz, 500 kHz, 600 kHz, 700 kHz, 800 kHz, 900 kHz, 1 MHz, 1.1 MHz, 1.2 MHZ, 1.3 MHz, 1.4 MHz, 1.5 MHz, 2 MHZ, 5 MHz, 10 MHZ, 20 MHZ, 30 MHz, 40 MHz, 50 MHz, 80 MHz, 100 MHz or 120 MHZ.

Such high switching frequencies are not achieved in multilevel converter systems which are used as a variable DC voltage or battery management systems.

At least one energy storage module can be heated directly with a high degree of efficiency using the method according to the invention.

Additional, external heating is not required in this case. The heat is thus produced directly at the location at which it is used, with the result that the energy storage modules are heated directly.

No heat transport losses occur and no additional components are required.

Developments of the invention can also be gathered from the dependent claims, the description and the accompanying drawings.

According to one embodiment, the transistor is in the form of a MOSFET or an IGBT or comprises a MOSFET or an IGBT.

Metal oxide semiconductor field-effect transistors (MOSFETs) or insulated gate bipolar transistors (IGBT) can be switched at high frequencies.

Silicon, gallium nitride, gallium arsenide and/or silicon carbide may be provided as the semiconductor material, for example. Organic semiconductors are also conceivable in principle.

For example, preconditioning and/or the setting of an operating optimum for MOSFETs is/are possible.

According to a further embodiment, at least one energy storage module is short-circuited for heating.

During normal operation, short circuits are usually intended to be avoided since they may damage the energy storage modules.

In contrast, in order to heat an energy storage module, short circuits can be intentionally produced. The short circuit that occurs produces a current flow that in turn produces heat which directly heats the energy storage module.

According to a further embodiment, the energy storage module is short-circuited for a maximum of 1 ms, preferably 1 μs, most preferably 1 ns.

Such short short-circuit times are mainly possible in multilevel converter systems.

The very short short-circuit times avoid damage to the energy storage modules since the current never becomes very high. The current increases with the time of the short circuit. The inductances in the circuit brake the increase to a certain extent.

According to a further embodiment, the switching carried out in a pulse-width-modulated manner.

A maximum short-circuit current corresponds to the quotient of the voltage of the energy storage module and the sum of the resistances of the energy storage module and of the transistor or transistors.

10 For example, for a voltage of the energy storage module of 4 V, an internal resistance of the energy storage module of 10 mΩ and with two transistors each having a resistance of 1 mΩ, the short-circuit current produces a value of 333.3 A. This produces a heat loss P=U*I of 1333 W in the event of a short circuit.

However, such a high heat loss is not necessary and is possibly also not beneficial to the health of the battery.

A limitation to 10 C, for example, is advantageous, where C corresponds to the discharge of the energy storage module in one hour. For example, this corresponds to a maximum short-circuit current of an energy storage module (with 3 Ah) of I=10*3 A=30 A.

It is therefore advantageous for the short circuit to be switched in a pulse-width-modulated (PWM) manner depending on the desired heating power.

Depending on the topology, the short circuit is possible at different transistors and can preferably be evenly distributed.

In principle, any transistor can produce a short circuit.

If there are a plurality of different possibilities for a short circuit, it is advantageous if they are used evenly. This makes it possible to ensure homogeneous heating of the transistors and of the energy storage module.

The majority of the losses occur in the energy storage module, whereas the heat input by the transistors plays a subordinate role in this case. However, this also has a positive aspect. With this type of converter, the power electronics are often fitted to the energy storage module and heat is input into the energy storage module via the contacts. The transistor is connected to the energy storage module directly, for example, via a metal material, for example copper.

A short circuit can be carried out, for example, during the journey of a vehicle. The voltage is not available to the converter at the time of the short circuit. However, this is not a problem on account of the short short-circuit times. The converter arm or current path is preferably not interrupted during this, with the result that no load dump and/or voltage dip occurs.

Only one, basically any, energy storage module can be short-circuited. Alternatively, a plurality of energy storage modules can also be short-circuited at the same time.

For example, in the case of a short circuit that contributes to the output voltage, two energy storage modules are always short-circuited at the same time.

According to a further embodiment, the switching frequency is increased for heating.

In this case, the switching frequency is preferably increased in comparison with the switching frequency that is required for normal, power-optimized operation.

The switching losses are increased by increasing the switching frequency. The deliberately produced losses result in a heat loss that is output directly in the region of the energy stores.

As also in the case of the variant with the artificially produced short circuit, use is likewise made here of effects which are intended to be prevented and/or avoided during normal, power-optimized operation.

It was surprising that these effects can be used to deliberately heat an energy storage module.

According to a further embodiment, at least two energy storage modules are connected in parallel for heating.

For example, the equalizing current, for example charging and/or discharging losses, can be used, in the state connected in parallel, to heat the energy storage modules.

According to a further embodiment, the energy storage modules connected in parallel have different states of charge.

For example, energy storage modules with different states of charge can be used to produce a charge balance between them by connecting them in parallel.

For example, one cell can be discharged and can then be connected in parallel with a fuller cell. This produces small graduations in the cell voltage, that is to say the cell voltage itself is divided to a certain extent. The cells are preferably not completely discharged. They are given virtually only a different history. A different voltage therefore remains for the same state of charge.

The different states of charge may arise during normal operation. Alternatively, they may also be deliberately produced.

For example, energy storage modules may be connected in series without connecting other energy storage modules in parallel with them. As a result, they are discharged to a greater extent than other energy storage modules during operation. This principle can be reversed during charging. For example, energy storage modules which are intended to be charged to a lesser extent can be connected in parallel more often.

The charge differences should preferably not be too large in this case in order to avoid damage to the energy storage modules. Equalization can be carried out, for example, by means of the power electronics, for example PWM. In this case, aging effects and/or frequency dependences of the energy storage modules can be taken into account.

If the charge differences are known, the charge can preferably be distributed evenly.

For example, the following voltage distribution may be present:
First energy storage module: 3.5 V
Second energy storage module: 4.2 V
Third energy storage module: 4.2 V
Fourth energy storage module: 4.2 V
Fifth energy storage module: 3.5 V
Sixth energy storage module: 4.2 V
Seventh energy storage module: 4.2 V
Eighth energy storage module: 4.2 V
Ninth energy storage module: 3.5 V

In this case, the first, fifth and ninth energy storage modules are discharged to a greater extent.

In order to now heat the energy storage modules, the energy storage module 1 is connected in parallel with energy storage module 2 and the energy storage module 5 is connected in parallel with energy storage module 6, for example, and at the same time energy storage module 8 is connected in parallel with energy storage module 9. If the losses are too high, PWM can be carried out.

This triggers an equalizing current of I=AU/R. In the example, four transistors are in the equalization loop during connection in parallel.

This results (if dynamic effects such as braking effects caused by the inductance are disregarded) in: I=(U [energy storage module 1]−U [energy storage module 2])/(4*R [transistor]+2*R [energy storage module]) flowing as the equalizing current.

Using the same example in the variant described above, this means that an energy storage module and the transistors result in an equalizing current of I=0.7 V/(4*1 mΩ+2*10 mΩ)=30 A. The energy storage modules are heated, on the one hand, by the heat P=I²*R=(30 A)²*10 mΩ=8.75 W, but also by the losses occurring at the transistors.

After this first step, the energy storage modules 1 and 2 and 5 and 6 and accordingly 8 and 9 have converged in terms of voltage. The equilibrium voltage is 3.85 V in this case:
First energy storage module: 3.85 V
Second energy storage module: 3.85 V
Third energy storage module: 4.2 V
Fourth energy storage module: 4.2 V
Fifth energy storage module: 3.85 V
Sixth energy storage module: 3.85 V
Seventh energy storage module: 4.2 V
Eighth energy storage module: 3.85 V
Ninth energy storage module: 3.85 V

In the next step, the energy storage module 2 is connected in parallel with energy storage module 3, and 5 is connected in parallel with 4 and 7 is connected in parallel with 8.

This produces a heat loss of P=I²*R=(15 A)²*10 mΩ=2.25 W for an equalization current of I=0.35 V/(4*1 mΩ+2*10 mΩ)=15 A.

In the last step, the heat distribution can now be equivalently distributed among energy all storage modules. Different methods for distributing the losses among all energy storage modules are possible in this case. The procedure shown here indicates only the simplest distribution. It is conceivable, for example, to quickly interrupt the charging processes again and again and to never cause complete equalization, but rather to carry out distribution in small substeps. Different starting temperatures and/or connections to the cooling circuit may likewise be discussed, for example. Alternatively or additionally, any aging differences could be compensated for.

This procedure can be used, for example, during ongoing operation of the converter. For this purpose, the energy storage modules are bridged to the outside, for example, and a short circuit can be produced only internally, for example.

In this case, a vehicle may be brought, for example, to the operating temperature and/or to the best charging temperature before charging, without losses for the customer.

Bridging to the outside is possible since the upper transistors of the energy storage modules must be closed anyway during connection in parallel.

The energy storage modules with different states of charge can be heated by connecting them in parallel, wherein charging and discharging losses occur. The charging or discharging power varies in most energy storage modules. For example, the charging power, for example 10 C, may be lower than the discharging power, for example 3 C. The charging power is the restrictive variable in this case in order to avoid damaging the energy storage module.

The energy storage modules to be heated can be used to produce the output voltage. This may result in superimposition with a load current that depends, for example, on the motor or power grid operating point.

Alternatively, the energy storage modules to be heated are not used to produce the output voltage. This makes it possible to predetermine the equalizing current in a very accurate manner.

According to a further embodiment, the configuration of the incorporated energy storage modules changes over time.

Selecting different configurations makes it possible to control the temperature, for example when driving. For example, a configuration with high losses can be selected in the case of energy storage modules that are too cold.

The configuration may preferably change in each stage. Alternatively or additionally, the configuration may be changed within a stage.

The energy storage modules can be incorporated into or excluded from a desired configuration.

Exclusion can be carried out, for example, by closing a switch, for example an upper switch, with the result that no current flows through the corresponding energy storage module.

According to a further embodiment, an energy storage module is connected alone or is connected in series with at least one other energy storage module for heating.

Losses of the energy storage modules are calculated according to P=I²*R [energy storage module]. The losses are dependent on the number of energy storage modules connected in parallel.

If only half of the energy storage modules are are incorporated into the configuration, the losses doubled.

For heating, for example selective heating, it is possible to select, for example, configurations in which energy storage modules are connected in series alone without parallel energy storage modules for reducing the current.

Heating can be carried out in this case during the journey, for example. The load current can be distributed by interconnecting the energy storage modules such that the energy storage modules are heated to a maximum extent.

Heating can be carried out even when the vehicle is at a standstill. In order to produce a load current, a current can be produced for this purpose by increasing a neutral point of an electric motor. As a result, it is possible to carry out charging back and forth between the individual phases.

For example, in the case of a three-phase structure with U1=100 V, U2=50 V and U3=100 V, phase 2 can be charged from phase 3 and phase 1. If these are connected purely in series, without using the possibility of connection in parallel, the losses can be maximized.

Alternatively or additionally, when producing this load current, all energy storage modules can be connected in parallel in order to heat all of them at the same time. This offset can be produced, for example, during the journey if the maximum output voltage is not yet required at the motor.

The method according to the invention means that there is no need for any additional components, for example heating elements or supply lines.

Furthermore, it is not necessary to monitor the heat distribution since the temperature is produced directly at the energy storage modules.

It is possible to individually heat the energy storage modules, with the result that there is no risk of uneven heating and/or inhomogeneities in the system can be compensated for.

The heat is produced at the location at which it is required and need not be first passed through the housing and/or all windings of the energy storage modules. The efficiency of the energy storage modules is therefore increased from the beginning of operation and the thermal stress of the overall structure is minimized.

The output of heat can preferably be adjusted in a continuously variable manner since the heating can be adjusted in any time steps, for example by means of pulse width modulation.

According to a further embodiment, on-state losses, the voltage, the current and/or the frequency is/are changed for heating.

A corresponding change preferably corresponds to connection of the energy storage modules in the sense of the invention.

It is possible, for example, to change the frequency such that it is in inductive and/or capacitive edge ranges, for example. These edge ranges would normally be avoided, in particular. However, these frequency ranges are suitable for heating.

The loads can be set using the frequencies, for example. If very fast switching is carried out, the charge carriers are not exchanged. For example, the frequency can be changed to the resonant frequency. As a result, it may even be possible, if necessary, to repair defective batteries again.

As an alternative or in addition to the frequency, on-state losses and/or the voltage and/or the current can be changed.

The voltage of individual cells depends on the state of charge and the (chemical) history of the cells. For example, a voltage difference can be produced. The cells can then be connected in parallel, with the result that the voltages are equalized. In contrast to a charge difference, this has the advantage that the maximum charge can be used.

For example, the internal resistance of some types of transistor, for example MOSFETs, depends on the voltage applied to the gate. However, the current may definitely be decisive in other types of transistor.

The gate terminal is the control terminal of the component. In the case of a MOSFET, there is the source, drain and gate. The voltage at the gate can be used to determine what resistance is present between the drain and source. The voltage at the gate may be changed, for example, in such a manner that the MOSFET is not completely turned on, that is to say assumes a state between on and off. This makes it possible to set the internal resistance of the switch and therefore the losses. If the voltage is halved, for example, the resistance is doubled.

The heating of the semiconductor can preferably be set on the basis of the relationship P=I²*R.

If the transistor is now heated to a greater extent, this heat can be dissipated into the battery via the electrically conductive connections that are present anyway, since the electrically conductive connections also transmit heat. The losses in the battery do not increase as a result, but the losses in the transistor do increase.

As a result, heating directly at the active material of the battery is possible, since the cathode and the anode extend through the entire battery. Therefore, the heat need not first pass from the outside through the housing and through the windings of the battery.

Each layer has a thermal internal resistance which counteracts the heating or slows it down over time. This can have a significant effect on the battery service life in a vehicle which is cold-started. Lithium ion batteries, in particular, age to a greater extent at negative temperatures.

This can be prevented by the method according to the invention.

The invention also relates to a multilevel converter system for carrying out the method according to the invention, having a multiplicity of energy storage modules and transistors, wherein each energy storage module is connected in parallel and/or in series with the respective adjacent energy storage module.

The system comprises a control apparatus which is designed to switch the energy storage modules, preferably the transistors, in such a manner that at least one energy storage module is heated.

At least one transistor has a switching frequency of at least 1 Hz.

All of the embodiments and components of the multilevel converter system described here are preferably designed to be operated, for example by means of a control apparatus, according to the method described here. Furthermore, all embodiments of the apparatus described here and all embodiments of the method described here can each be combined with one another, preferably also in a manner detached from the specific configuration, in connection with which they are mentioned. For example, two or more of the heating methods may also be carried out at the same time or in succession, depending on requirements.

The invention is described by way of example below with reference to the drawings, in which:

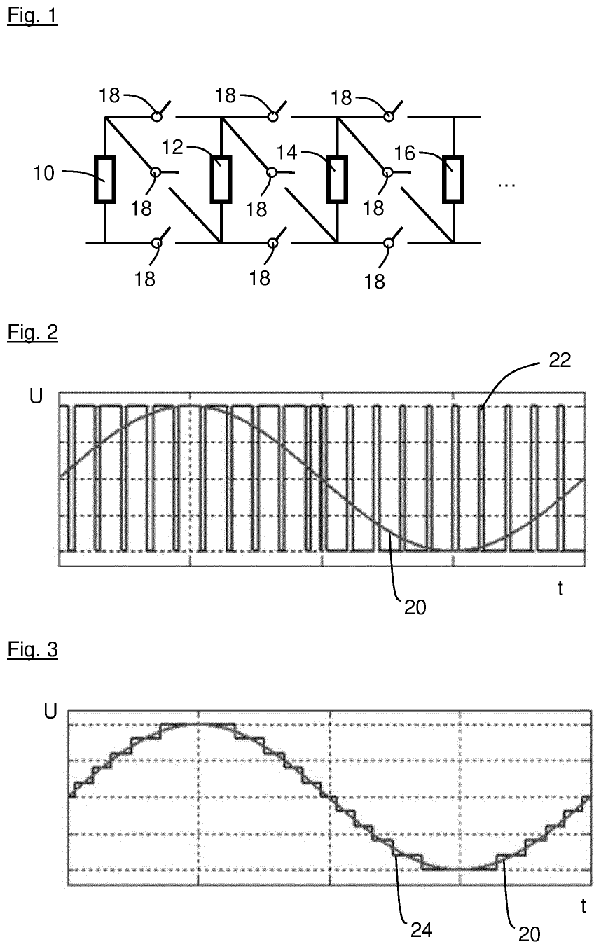

FIG. 1 shows an embodiment of an MMC system according to the invention,

FIG. 2 shows a profile of the output voltage of a PWM system according to the prior art,

FIG. 3 shows a profile of the output voltage of an embodiment of an MMC system according to the invention,

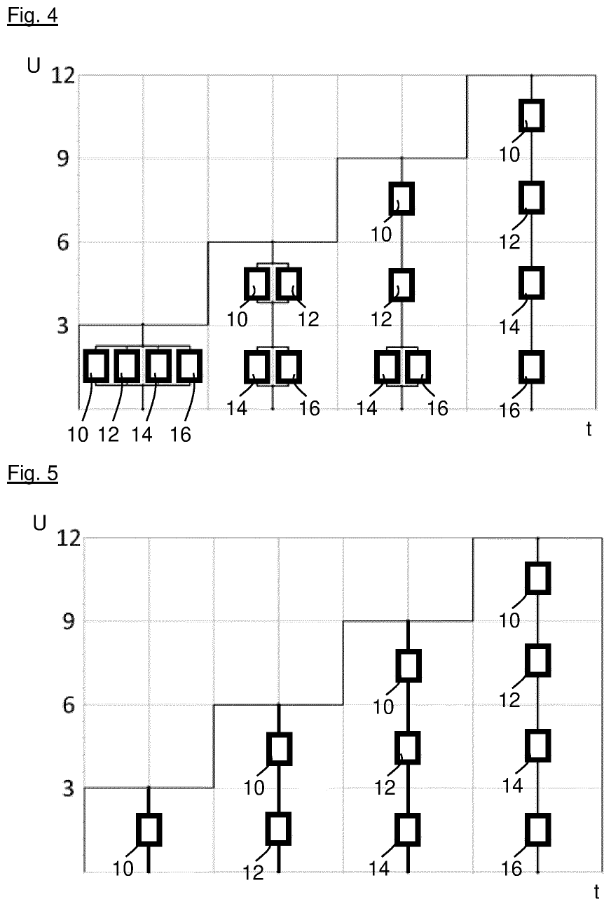

FIG. 4 shows a power (loss)-optimized configuration of an MMC system according to the prior art,

FIG. 5 shows a configuration of an embodiment of an MMC system according to the invention for heating energy storage modules, and

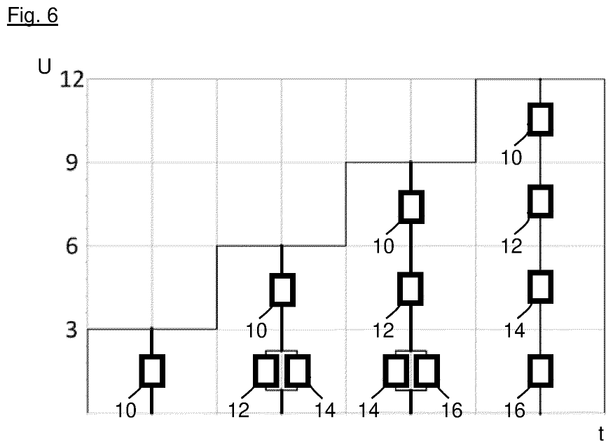

FIG. 6 shows a configuration of a further embodiment of an MMC system according to the invention for heating energy storage modules.

It should first of all be noted that the embodiments illustrated are of a purely exemplary nature. Individual features can therefore be implemented not only in the combination shown, but also alone or in other technically meaningful combinations. For example, the features of one embodiment can be combined in any desired manner with features of another embodiment. The configuration and/or number of energy storage modules, paths and transistors shown is/are purely exemplary and fundamentally arbitrary.

If a figure contains a reference sign which is not explained in the directly associated text of the description, reference is made to the corresponding preceding or subsequent comments in the description of the figures. The same reference signs are therefore used for identical or comparable components in the figures and are not explained again.

FIG. 1 shows a multilevel converter system for directly heating at least one energy storage module 10, 12, 14, 16.

Adjacent energy storage modules 10, 12, 14, 16 are each connected to one another via a plurality of paths.

A switch in the form of a transistor 18 is provided in each path.

The adjacent energy storage modules 10, 12, 14, 16 can therefore be connected in series or in parallel with one another. Individual energy storage modules 10, 12, 14, 16 can also be bridged if necessary, for example by closing the upper switch 18, and can be excluded from a configuration in this manner.

FIG. 2 illustrates the voltage profile U against the time t of a PWM modulation.

Six switches are required in this case for three-phase DC/AC system coupling.

In the case of a B6 bridge or a two-point converter, the DC voltage is synchronously switched on via a plurality of switches or one switch, thus resulting in an AC voltage only on average over time.

The sinusoidal target voltage 20 is therefore only rudimentarily recreated by the output voltage 22 of the PWM system.

FIG. 3 shows the voltage profile U in volts against the time t in seconds of an MMC system.

The sinusoidal target voltage 20 is emulated by the structure of individual stages 24. The output voltage 24 therefore emulates the sinusoidal target voltage 20 in a considerably improved manner.

FIG. 4 shows a power (loss)-optimized configuration of an MMC system. The voltage U is illustrated in volts against the time t in seconds.

For example, it is shown how the first three voltage stages can be formed by connecting the energy storage modules 10, 12, 14, 16 in parallel.

In order to optimize the power and obtain the best efficiency, all energy storage modules 10, 12, 14, 16 are always incorporated into the configuration in each stage.

In contrast, FIG. 5 shows a configuration in which all energy storage modules 10, 12, 14, 16 are connected in series. This results in a maximum heating power.

In this example, the energy storage module 10 is heated to the greatest extent and the energy storage module 16 is heated to the least extent.

FIG. 6 illustrates a configuration in which the energy storage module 10 experiences the maximum heating power since it is always alone in the current path.

In the first stage, the energy storage module 10 is connected alone and, in the further stages, it is connected in series with at least one of the other energy storage modules 12, 14, 16.

The configurations illustrated in FIGS. 5 and 6 are purely exemplary. Other configurations are likewise conceivable depending on which energy storage module(s) 10, 12, 14, 16 is/are intended to be heated.

Since each energy storage module 10, 12, 14, 16 can be controlled separately, even minor differences can be compensated for. For example, a cooling system of a vehicle may have discrepancies in the coolant temperatures which can be actively compensated for. It is also possible to increase the temperature of individual energy storage modules 10, 12, 14, 16 dynamically for specific load situations.

### LIST OF REFERENCE SIGNS

10, 12, 14, 16 Energy storage module
18 Transistor
20 Target voltage
22 PWM system output voltage
24 Stage, MMC system output voltage
U Voltage
t Time

1. A method for directly heating at least one energy storage module (10, 12, 14, 16) with a multilevel converter system, in which
a multiplicity of energy storage modules (10, 12, 14, 16) and transistors (18) are provided, wherein each energy storage module (10, 12, 14, 16) can be connected in parallel and/or in series with the respective adjacent energy storage module (10, 12, 14, 16), and
the energy storage modules (10, 12, 14, 16) are switched in such a manner that at least one energy storage module (10, 12, 14, 16) is heated,
wherein at least one transistor (18) has a switching frequency of at least 1 Hz.

2. The method as claimed in claim 1, wherein the transistor (18) is in the form of a MOSFET or an IGBT or comprises a MOSFET or an IGBT.

3. The method as claimed in claim 1, wherein at least one energy storage module (10, 12, 14, 16) is short-circuited for heating.

4. The method as claimed in claim 3, wherein the energy storage module (10, 12, 14, 16) is short-circuited for a maximum of 1 ms.

5. The method as claimed in claim 1, wherein the switching is carried out in a pulse-width-modulated manner.

6. The method as claimed in claim 1, wherein the switching frequency is increased for heating.

7. The method as claimed in claim 1, wherein at least two energy storage modules (10, 12, 14, 16) are connected in parallel for heating.

8. The method as claimed in claim 7, wherein the energy storage modules (10, 12, 14, 16) connected in parallel have different states of charge.

9. The method as claimed in claim 1, wherein the configuration of the incorporated energy storage modules (10, 12, 14, 16) changes over time.

10. The method as claimed in claim 9, wherein an energy storage module (10) is connected alone or is connected in series with at least one other energy storage module (12, 14, 16) for heating.

11. The method as claimed in claim 1, wherein on-state losses are changed for heating.

12. The method as claimed in claim 1, wherein the voltage and/or the current is/are changed for heating.

13. The method as claimed in claim 1, wherein the frequency is changed for heating.
